(19) United States
(12) Patent Application Publication
(10) Pub. No.: US 2026/0038534 A1
(43) Pub. Date: Feb. 5, 2026

(54) DISK DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Makoto Okamoto, Kodaira Tokyo (JP); Takuma Kido, Mitaka Tokyo (JP); Toru Watanabe, Kawasaki Kanagawa (JP); Koji Sonoda, Yokohama Kanagawa (JP); Takeyori Hara, Kawasaki Kanagawa (JP); Takayuki Kawabe, Sagamihara Kanagawa (JP)

(21) Appl. No.: 18/999,157

(22) Filed: Dec. 23, 2024

(30) Foreign Application Priority Data
Aug. 2, 2024 (JP) 2024-127819

(51) Int. Cl. G11B 33/14; G11B 25/04; G11B 33/02

(52) U.S. Cl. CPC G11B 33/1453; G11B 25/043; G11B 33/022

(57) ABSTRACT

According to one embodiment, a disk device includes a housing filled with a low density gas containing oxygen and having a density lower than a density of air, a disk-shaped recording medium provided in the housing to be rotatable, a spindle motor provided in the housing and supporting and rotating the recording medium, and a magnetic head including a heat assist element which heats the recording medium. A surface of magnet of the spindle motor is covered with a shielding film blocking oxygen permeation.

### CROSS-REFERENCE TO RELATED APPLICATIONS

This application is based upon and claims the benefit of priority from Japanese Patent Application No. 2024-127819, filed Aug. 2, 2024, the entire contents of which are incorporated herein by reference.

### FIELD

Embodiments described herein relate generally to a disk device.

### BACKGROUND

A magnetic disk device in which an inert gas such as helium is sealed in its housing is well known as a disk device. In addition, in recent years, a magnetic disk device using a magnetic head of heat assisted magnetic recording (HAMR) method has been proposed. HAMR is a technology of increasing the recording capacity by heating the recording medium with a laser during recording.

In order to ensure the reliability of HAMR, it is necessary for the disk device to contain oxygen of 3% or more. For this reason, helium mixed with oxygen is desirably used instead of 100% helium, as the gas sealed in the housing.

In general, components provided inside the housing of the disk device consume oxygen through chemical reactions. For this reason, in order to ensure the reliability, it is necessary to fill the disk device with oxygen of 10% or more. However, increasing the oxygen content ratio increases the density of the gas, which leads to a deterioration in disk drive performance such as a deterioration in head positioning accuracy and an increase in power consumption. Coating the components with resin such as epoxy is considered as one possible measure to prevent oxidation and corrosion, but it is difficult to completely cover the surface of the components, and exposed areas such as pinholes are present. If pinholes are present, in a case where oxygen-mixed helium is used, oxygen is consumed by oxidation.

### BRIEF DESCRIPTION OF THE DRAWINGS

FIG. 1 is an exploded perspective view showing a hard disk drive (HDD) according to a first embodiment with a top cover detached.

FIG. 2 is a side view schematically showing a distal portion of a suspension assembly and a magnetic head, in the HDD.

FIG. 3 is a cross-sectional view showing a spindle motor portion of the HDD.

FIG. 4 is a table showing measurement results of measuring an oxygen consumption of components of the HDD.

FIG. 5 is an enlarged cross-sectional view showing a magnet of the spindle motor.

FIG. 6 is a graph showing a comparison of the oxygen consumption for each coating film.

### DETAILED DESCRIPTION

Various embodiments will be described hereinafter with reference to the accompanying drawings. In general, according to one embodiment, a disk device includes a housing filled with a low density gas containing oxygen and having a density lower than a density of air, a disk-shaped recording medium provided in the housing to be freely rotatable, a spindle motor provided in the housing, supporting and rotating the recording medium, and including a magnet whose surface is covered with a shielding film blocking oxygen permeation, and a magnetic head including a heat assist element which heats the recording medium.

The disclosure is merely an example, and proper changes within the spirit of the invention, which are easily conceivable by a person of ordinary skill in the art, are included in the scope of the invention as a matter of course. In addition, in some cases, in order to make the description clearer, the widths, thicknesses, shapes and the like, of the respective parts are schematically illustrated in the drawings, compared to the actual modes. However, the schematic illustration is merely an example, and adds no restriction to the interpretation of the invention. Besides, in the specification and drawings, the same elements as those described in connection with preceding drawings are denoted by like reference numbers, and a detailed description thereof is omitted or simplified unless necessary.

### Embodiment

A hard disk drive (HDD) according to an embodiment will be described in detail as a disk device.

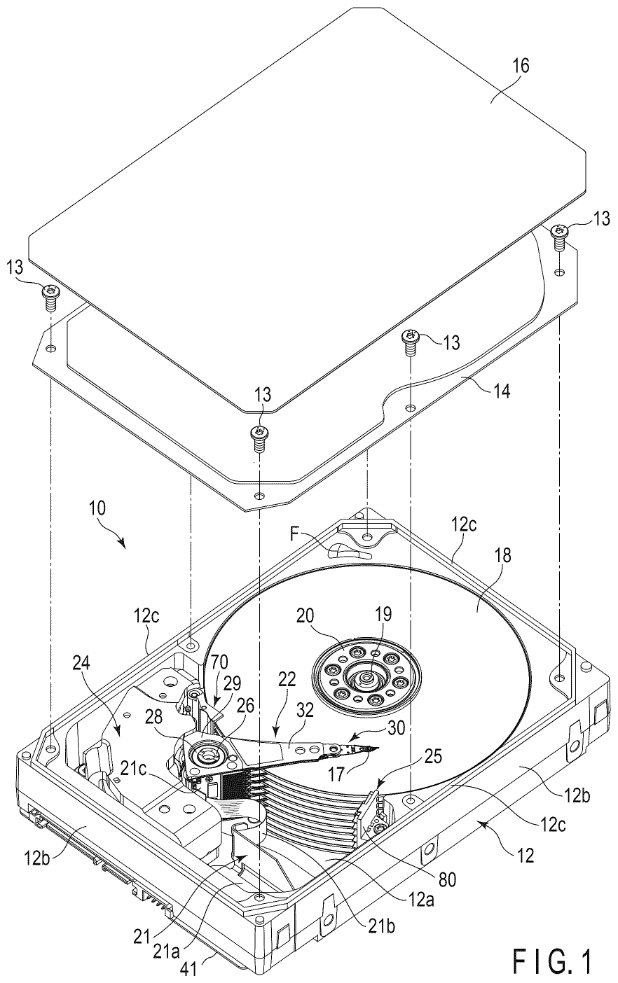

FIG. 1 is an exploded perspective view showing the HDD according to the embodiment with a cover removed.

As shown in FIG. 1, the HDD comprises a substantially rectangular housing 10. The housing 10 includes a base 12 having a shape of a rectangular casing with an upper end opening, an inner cover 14 which is screwed on the base 12 with a plurality of screws 13 and which closes the upper end opening of the base 12, and an outer cover (top cover) 16 which is arranged to overlap with the inner cover 14 with a peripheral portion welded to the base 12. The base 12 includes a rectangular bottom wall 12a facing the inner cover 14 with a gap therebetween, and a side wall 12b erected along a peripheral edge of the bottom wall 12a, and is, for example, formed of an aluminum alloy and molded integrally. The side wall 12b includes a pair of long-side walls that are opposed to each other and a pair of short-side walls that are opposed to each other. A fixing rib 12c shaped in a substantially rectangular frame is provided to protrude on an upper end surface of the side wall 12b.

The inner cover 14 is, for example, formed of stainless steel and formed in a shape of a rectangular plate. A peripheral edge portion of the inner cover 14 is screwed to an upper surface of the side wall 12b by the screws 13 and is fixed to an inner side of the fixing rib 12c. The outer cover 16 is, for example, formed of aluminum in a shape of a rectangular plate. The outer cover 16 is formed to be slightly larger than the inner cover 14 in planar dimensions. A peripheral edge portion of the outer cover 16 is welded to the fixing rib 12c of the base 12 along the entire periphery and is fixed airtightly to the base 12. The airtightly closed housing 10 is filled with a low density gas having a density lower than air, for example, helium (He). In the embodiment, the low density gas contains, for example, oxygen of approximately 5% in rate. The oxygen rate (oxygen concentration) is desirably set to a range of 1% or more and 10% or less. Furthermore, a relative humidity inside the housing 10 is adjusted to 3% or less. In one example, the relative humidity inside the housing can be maintained at 3% or less by arranging a moisture absorbent (desiccant) with excellent moisture absorption properties, such as zeolite, inside the housing 10.

A plurality of, for example, ten magnetic disks 18 that are disk-shaped recording media, and a spindle motor (SPM) 19 serving as a drive motor that supports and rotates the magnetic disks 18 are provided inside the housing 10. The spindle motor 19 is provided on the bottom wall 12a. Each of the magnetic disks 18 is formed in a disk shape having a diameter of, for example, 96 mm (3.5 inches). Each of the magnetic disks 18 includes a substrate formed of a non-magnetic material, for example, glass, and a magnetic recording layer formed on the upper surface and/or lower surface of the substrate.

The magnetic disks 18 are fitted coaxially in a hub of the spindle motor 19, which will be described later, and are further clamped by a clamp spring 20. The magnetic disk 16 is thereby supported in a state of being positioned parallel to the bottom wall 12a of the base 12. The plurality of magnetic disks 18 are rotated at a predetermined number of revolutions by the spindle motor 19. Incidentally, the number of magnetic disks 18 mounted is not limited to ten, but may be nine or less, or eleven or more.

In the housing 10 are provided a plurality of magnetic heads 17 for recording and reproducing information on the magnetic disks 18, and an actuator assembly 22 that supports these magnetic heads 17 to be movable with respect to the magnetic disks 18. In addition, a voice coil motor (VCM) 24 that rotates and positions the actuator assembly 22, a ramp load mechanism 25 that holds the magnetic heads 17 in an unloaded position remote from the magnetic disks 18 when the magnetic heads 17 move to the outermost circumference of the magnetic disks 18, a board unit (FPC unit) 21 on which electronic components such as a conversion connector are mounted, a spoiler 70, and a circulation filter F, are provided in the housing 10. The VCM 24 includes a pair of yokes and a magnet (not shown) fixed to the yokes.

The ramp load mechanism 25 includes a ramp 80 attached to the base 12, and a lift tab provided at a distal end of the actuator assembly, which will be described later. The board unit 21 integrally includes a base portion 21a, an elongated strip-shaped relay portion 21b extending from one side edge of the base portion 21a, and a joint portion 21c continuously provided at a distal end of the relay portion 21b. The base portion 21a, the relay portion 21b, and the junction portion 21c are formed by a flexible printed circuit board (FPC). The base portion 21a is fixed to the bottom wall 12a. The joint portion 21c is connected to the actuator assembly 22.

A printed circuit board 41 is screwed to the outer surface of the bottom wall 12a of the base 12. The printed circuit board 41 constitutes a control unit that controls the operation of the spindle motor 19, the operation of the VCM, and the operation of the magnetic heads 17.

As shown in FIG. 1, the actuator assembly (head stack assembly: often referred to as HSA) 22 comprises an actuator block 29 having a through hole 26, a bearing unit 28 provided in the through hole 26, a plurality of, for example, eleven arms 32 extending from the actuator block 29, a suspension assembly (head gimbal assembly: often referred to as HGA) 30 attached to each of the arms 32, and a magnetic head 17 supported by the head suspension assembly 30. A support shaft (pivot shaft) (not shown) is erected on the bottom wall 12a of the base 12. The actuator block 29 is supported by the bearing unit 28 so as to be freely rotatable around the support shaft.

The actuator assembly 22 includes a support frame (not shown) extending from the actuator block 29 in the direction opposite to the arm 32, and a voice coil constituting a part of the VCM 24 is supported by this support frame.

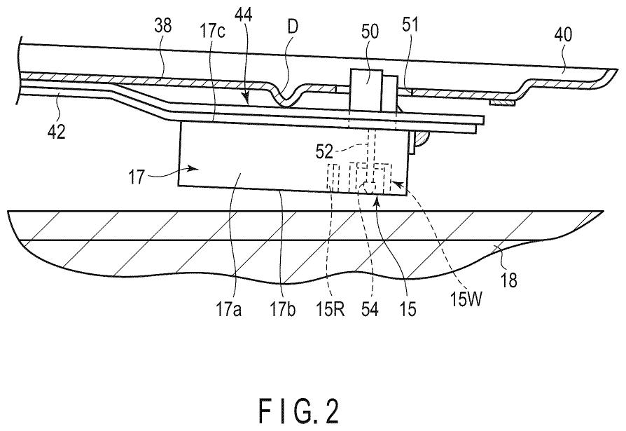

FIG. 2 is a side view schematically showing a distal end portion of the suspension assembly 30 and the magnetic head 17.

As shown in FIG. 2, the suspension assembly 30 includes a base plate (not shown) attached to the arm 32, a load beam 38 shaped in an elongated leaf spring extending from the base plate, and a flexure (wiring member) 42 shaped in an elongated strip. The flexure 42 includes a gimbal portion 44 which is elastically deformable, and the magnetic head 17 is placed on this gimbal portion 44. A lift tab 40 protrudes from the distal end of the load beam 38. The lift tab 40 is configured to engage with the above-described ramp 80, and constitutes the ramp load mechanism 25 together with the ramp 80.

The load beam 38 includes a dimple D protruding toward the magnetic head 17 side and an opening 51 formed between the dimple D and the lift tab 40. The dimple D is in contact with a substantially central part of the magnetic head 17 via the gimbal portion 44. As a result, the gimbal portion 44 and the magnetic head 17 can pivot in the pitch and roll directions around dimple D.

The magnetic head 17 includes a slider 17a having a shape of a substantially flat rectangular parallelepiped and a head portion 15 provided on the slider 17a. The head portion 15 includes a recording element (write head) 15W and a read element (read head) 15R. The slider 17a includes an air bearing surface (ABS) 17b that faces the surface of the magnetic disk 18, and a back surface 17c on an opposite side. In the magnetic head 17, the back surface 17c of the slider 17a is placed on the gimbal portion 44 and, for example, fixed to the gimbal portion 44 with adhesive.

The magnetic head 17 constitutes a head of the heat assisted magnetic recording (HAMA) method. The magnetic head 17 further comprises a heat assist element configured to heat the magnetic disk 18. In the embodiment, the heat assist element includes a laser oscillator, for example, a laser diode unit (LDU) 50, which functions as a light source, a waveguide 52 that guides the laser beam oscillated from the LDU 50 to the magnetic disks 18, and a light emitting element, for example, a near-field light generating element 54, which emits a laser beam onto the magnetic disk 18.

The LDU 50 is installed on the back surface 17c of the slider 17a and extends in a direction substantially orthogonal to the back surface 17c. The LDU 50 is inserted into the opening 51 of the load beam 38. The waveguide 52 and the near-field light generating element 54 are provided in the slider 17a. The laser beam generated by the LDU 50 is input to the waveguide 52 and propagated to the near-field optical element 73 through the waveguide 52. The near-field optical element 54 generates near-field light and emits the light to the surface of the magnetic disk 18. The magnetic recording layer of the magnetic disk 18 is thereby heated locally.

The read head 15R, the write head 15W, and the LDU 50 of the magnetic head 17 are electrically connected to the control unit of the HDD via interconnects of the flexure 42 and interconnects of the FPC unit 21.

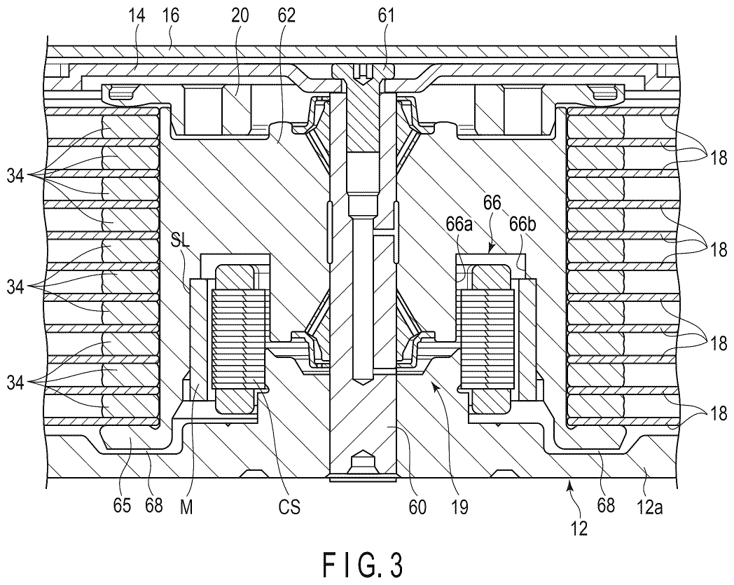

Next, the structure of the spindle motor will be described. FIG. 3 is a cross-sectional view of the HDD including the spindle motor 19.

As shown in FIG. 3, in one example, the spindle motor 19 includes a pivot shaft 60 that is erected substantially orthogonally to the bottom wall 12a, a substantially cylindrical hub (rotor) 62 supported to be rotatable around the pivot shaft 60, a stator coil CS fixed to the bottom wall 12a and arranged around the hub 62, and a cylindrical magnet M attached to the hub 62 and opposed to the stator coil CS. An extending end of the pivot shaft 60 is screwed to the inner cover 14 using a fixing bolt 61.

The hub 62 has an outer circumferential surface that is located coaxially with the pivot shaft 60 and an annular flange 65 that is integrally formed at a lower end of the outer circumferential surface (i.e., the end on the side of the bottom wall 12a). A cylindrical recess 66 is formed on the bottom surface side of the hub 62, i.e., the end portion on the side of the bottom wall 12a. The recess (often referred to as a space portion) 66 is open to the bottom surface of the hub 62. The recess 66 has an inner circumferential surface 66a and an outer circumferential surface 66b that are located coaxially with the pivot shaft 60. The inner circumferential surface 66a and the outer circumferential surface 66b are opposed in parallel to each other with a gap therebetween.

The stator coil CS is fixed to the bottom wall 12a, and its most part is housed in the recess 66. The stator coil CS is located coaxially with the pivot axis 60 and is spaced from and opposed to the inner circumferential surface 66a and the outer circumferential surface 66b of the recess 66.

The magnet M is arranged in the recess 66 and is fixed to the outer circumferential surface 66b of the recess 66. The magnet M is arranged coaxially with the pivot shaft 60 and is spaced from and opposed to the entire stator coil CS. As described later, the entire outer surface (surface) of the magnet M is covered with a shielding film SL.

The bottom surface of the hub 62 and the flange 65 are opposed to the bottom wall 12a with a small gap therebetween. A complexly bent or curved passage 68 is thereby formed between the bottom surface of the hub 62 and the flange 65, and the bottom wall 12a. This passage 68 forms a labyrinth seal. The recess 66 in which the magnet M is provided communicates with an inner space of the housing 10 via the passage 68 (labyrinth seal).

The magnetic disks 18 are engaged with the outer circumferential surface of the hub 62 in a state in which the hub 62 is inserted through the inner holes of the magnetic disks 18. An annular spacer ring 34 is attached to the outer circumferential surface of the hub 62 and is sandwiched between two adjacent magnetic disks 18. A plurality of magnetic disks 18 and a plurality of spacer rings 34 are arranged in order on the flange 65 of the hub 62 and are attached to the hub 62 in a state of being stacked alternately. The disk-shaped clamp spring 20 is attached to the upper end of the hub 62. The clamp spring 20 presses the inner circumferential parts of the plurality of magnetic disks 18 and the spacer rings 34 toward the flange 65 side. The plurality of magnetic disks 18 are thereby spaced apart at predetermined intervals and fixed in a stacked state. Ten magnetic disks 18 are supported so as to be rotatable together with the hub 62 of the spindle motor 19. The ten magnetic disks 18 are spaced apart at predetermined intervals and supported parallel to each other and substantially parallel to the bottom wall 12a.

According to the HDD, the plurality of magnetic heads 17 are moved to a desired seek position, in a state of being opposed to the surface of each of the magnetic disks 18, by rotating the actuator assembly 22 around the support shaft 31 by the VCM 24. During the recording operation, each of the magnetic heads 17 performs heat assisted magnetic recording. When the HDD is not in operation and the magnetic head 17 moves off the outer circumference of the magnetic disk 18 to a predetermined stop position, each of the lift tabs 40 of the plurality of suspension assemblies rides on a guide surface of the corresponding ramp 80. The magnetic head 17 is thereby held in the unload position separated from the magnetic disk 18 by the ramp 80.

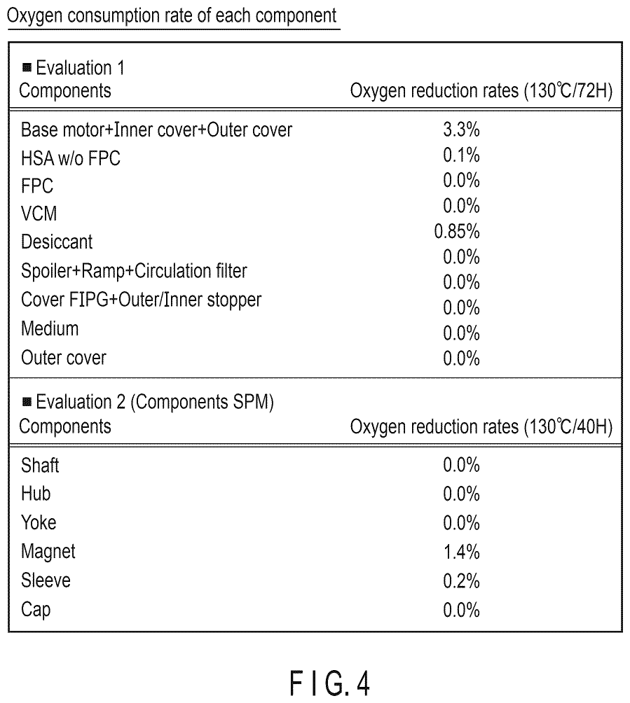

The present inventors, and the like conducted inspections and analyses of the oxygen consumption rate (oxygen reduction rate) of each of the components that constitute the HDD. FIG. 4 shows the inspection results (Evaluation 1) for the components and the inspection results (Evaluation 2) for the components of the SPM. Evaluation 1 shows the oxygen reduction rates when the components are left in an environment at 130° C. for 72 hours. Evaluation 2 shows the oxygen reduction rates when the components of the SPM are left in an environment at 130° C. for 40 hours.

In FIG. 4, a base motor indicates Base 12+SPM 19. In addition, FIPG indicates a gasket of the cover. Desiccant indicates the moisture absorbent.

As shown in FIG. 4, it can be understood that in Evaluation 1, the component “base motor+inner cover+outer cover” has the highest oxygen reduction rate. As in Evaluation 2, it can be seen that among the components of the SPM, the magnet has the highest oxygen reduction rate. The present inventors have found from the above inspection results that in the HDD, the magnet M of the SPM is the component with the highest oxygen consumption rate. In other words, the present inventors have found that the magnet M is a component which is relatively difficult to come into contact with the interior air of the housing 10 since the magnet M is arranged in the recess 66 of the hub 62, which communicates with the interior of the housing through the passage 68 (labyrinth seal), but the magnet M easily consumes oxygen.

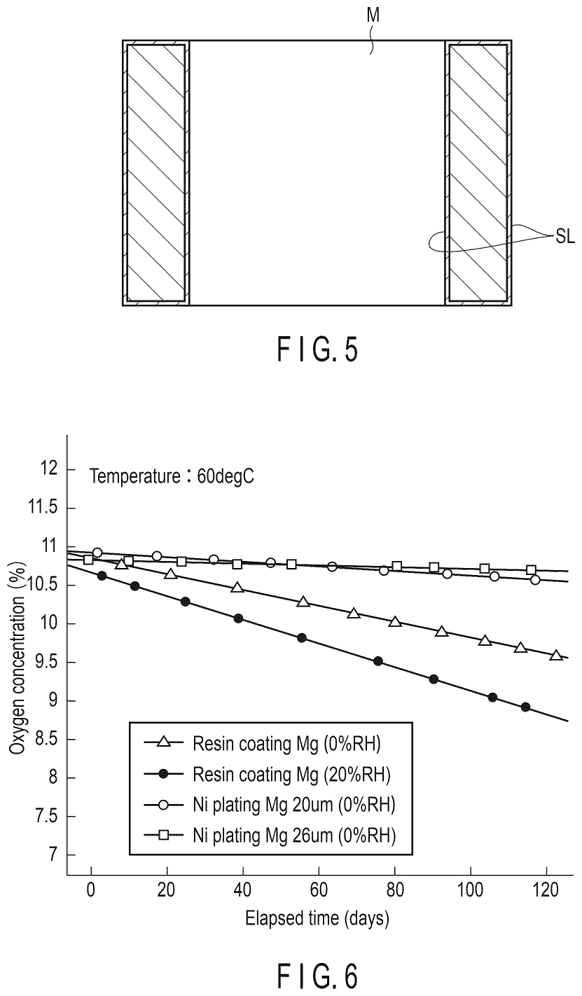

Therefore, according to the HDD of the embodiment, as shown in FIG. 5, a shielding film SL is coated on the entire surface of the magnet M, which is a component consuming a large amount of oxygen. In the embodiment, in one example, the shielding film SL is formed with a Ni plating layer. The thickness of the shielding film SL is formed to be, for example, approximately 20 to 26 μm. The thicker the shielding film SL, the greater its oxygen shielding capacity. An upper limit of the film thickness may not be therefore set. The absorption and consumption of oxygen in the magnet M can be suppressed and the reduction in oxygen inside the housing 10 can be suppressed by the shielding film SL.

In the embodiment, the shielding film refers to a film that blocks the permeation of oxygen. More specifically, the shielding film SL refers to a film formed of a material (not containing resin) with a density of, for example, 2 to 20 g/cm³.

Examples of the shielding layer SL include metal plating layers, for example, Ni plating, multilayered metal plating layers, for example, Ni—Cu—Ni plating, silicon nitride films, and diamond-like carbon (DLC) coating films.

The density of the coating layer of resin, for example, epoxy, is 1.1 to 1.2 g/cm³. In contrast, the density of the Ni plating layer is 8.9 g/cm³, the density of the DLC is 1.9 to 3.1 g/cm³, and the density of silicon nitride (Si—N) is 3.1 g/cm³, all of which are higher than the density of resin.

FIG. 6 is a graph showing a comparison of the oxygen consumption rate for each coating film.

As shown in FIG. 6, the decrease in oxygen concentration is suppressed to a low level for two types of Ni plating layers having different thicknesses, for two types of resin-coated Mg. In addition, it can also be understood that the thicker the Ni plating layer, the more it can suppress the decrease in oxygen concentration.

As described above, according to the HDD of the embodiment, by coating, i.e., covering the entire surface of the magnet M having a large oxygen consumption rate with the shielding film SL, the absorption and consumption of oxygen in the magnet M can be suppressed, thereby suppressing the decrease in oxygen in the housing 10, by the shielding film SL. Accordingly, the oxygen content ratio of the helium filling the housing 10 can be reduced to, for example, 5%, and both improvement in reliability of a HAMR-type disk device and the maintenance of the disk device performance can be achieved.

Furthermore, the chemical reactions caused by moisture can be reduced and the oxygen consumption of the components can be further suppressed by reducing the relative humidity inside the housing 10 to 3% or less.

As described above, according to the embodiment, the disk device capable of suppressing the oxygen consumption inside the device and improving the reliability can be obtained.

While certain embodiment have been described, the embodiment have been presented by way of example only, and is not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the shielding film of the components is not limited to a Ni plating layer, but various other types of shielding film can be applied as the shielding film. In other words, various types of film with a density of 2 to 20 g/cm³ can be selected. In addition, the thickness of the shielding film is not limited to that in the embodiment, but can be changed as appropriate. Furthermore, the shielding films can also be applied to other components as well as the magnet M.

What is claimed is:

1. A disk device comprising:
a housing filled with a low density gas containing oxygen and having a density lower than a density of air;
a disk-shaped recording medium provided in the housing to be rotatable;
a spindle motor provided in the housing, supporting and rotating the recording medium, and including a magnet whose surface is covered with a shielding film blocking oxygen permeation; and
a magnetic head including a heat assist element which heats the recording medium.

2. The disk device of claim 1, wherein
the shielding film is a film of diamond-like carbon.

3. The disk device of claim 1, wherein
the shielding film is a silicon nitride film.

4. The disk device of claim 1, wherein
the shielding film is formed of a metal plating layer.

5. The disk device of claim 4, wherein
the metal plating layer is a Ni plating layer.

6. The disk device of claim 4, wherein
the metal plating layer is a multilayered metal plating layer.

7. The disk device of claim 1, wherein
the shielding film has a thickness of 20 to 26 μm or more.

8. The disk device of claim 1, wherein
an oxygen concentration of the low density gas is 1% or more and 10% or less.

9. The disk device of claim 1, wherein
a relative humidity inside the housing is 38 or less.

10. The disk device of claim 1, wherein
the spindle motor comprises a pivot shaft erected in the housing, a hub supported to be rotatable around the pivot shaft, a stator coil, and the magnet attached to the hub, and
the hub includes a space portion wherein the magnet is arranged, and the space portion communicates with space in the housing via a labyrinth seal defined between the hub and the housing.
